(19) United States
(12) Patent Application Publication
(10) Pub. No.: US 2012/0193168 A1
(43) Pub. Date: Aug. 2, 2012

(54) PORTABLE SAFTEY DEVICE AND METHOD

(76) Inventors: David Taylor, (US); Rick Kilpatrick, (US); David Wilbanks, (US)

(21) Appl. No.: 13/356,313

(22) Filed: Jan. 23, 2012

Related U.S. Application Data
(60) Provisional application No. 61/436,630, filed on Jan. 27, 2011.

(51) Int. Cl. A62B 1/16; G09F 17/00; B23P 11/00; E04G 5/14

(52) U.S. Cl. 182/231; 182/112; 116/173; 29/407.01

(57) ABSTRACT

According to one or more aspects, a portable safety device operable to be deployed adjacent to a work surface. The portable safety device may include a rail and a locking device disposed with the rail and operable to secure the rail to the work surface. According to one or more aspects or embodiments, the device may include a signal member operationally connected to the rail to provide a visual indicator that the rail is secured to the work surface.

### CROSS-REFERENCE TO RELATED APPLICATIONS

This application claims priority from, and incorporates by reference for any purpose the entire disclosure of, U.S. Provisional Patent Application No. 61/436,630, filed Jan. 27, 2011.

### BACKGROUND

This section provides background information to facilitate a better understanding of the various aspects of the invention. It should be understood that the statements in this section of this document are to be read in this light, and not as admissions of prior art.

This application relates generally to fall-prevention devices. More particularly, but not by way of limitation, this application relates to portable safety devices for use during work upon an elevated work surface such as, for example, a flatbed trailer.

Flatbed trailers are very common in industry as a means for transporting, for example, pallets or coils of raw material. In fact, of approximately 2.8 million trailers in use in the United States, it is estimated that ten percent are flatbed trailers. Flatbed trailers are typically not subject to the dimensional load restrictions commonly associated with enclosed trailers. However, the process of loading and unloading flatbed trailers can present numerous safety hazards for workers. Chief among these hazards is the risk of falling.

Today, falls are the second-leading cause of fatal workplace accidents accounting for approximately 13% of all workplace fatalities. Certain characteristics of flatbed trailers make them particularly hazardous. For example, many flatbed trailers have poorly-maintained decking which presents a risk for tripping or loss of balance. Furthermore, materials being shipped often shift during transport and become unstable. This situation creates uneven footing for a worker and may result in a situation where a worker is knocked from a trailer by a falling load. Industry research indicates that falls from trailers account for, on average, 50 work-related deaths per year. While most falls from trailers involve the driver, any person working on a flatbed trailer during loading, unloading, or securing of a load is potentially at risk. It is important to note that, at present, there is no U.S. regulatory mandate for minimizing the risk of trailer falls.

### SUMMARY

According to one or more aspects, a portable safety device operable to be deployed adjacent to a work surface. The portable safety device may include a rail and a locking device disposed with the rail and operable to secure the rail to the work surface. According to one or more aspects or embodiments, the portable safety device may include a signal member operationally connected to the rail to provide a visual indicator that the rail is secured to the work surface.

According to one or more aspects of the invention, a portable safety device operable to be deployed adjacent to a work surface. According to various embodiments, the device may include a rail comprising a first rail section telescopically connected to a second rail section and a locking device disposed with the rail. The locking device is operable to secure the rail to the work surface. According to one or more aspects or embodiments, the device may include a signal member. The signal member may be operationally connected to the rail and positioned in a secured signal position in response to the locking device being removably secured to the work surface. The secured signal position provides a visual indicator that the rail is secured to the work surface.

According to one or more aspects, a method of preventing falls may comprise positioning a portable safety device adjacent to a work surface, adjusting a length of the portable safety device to correspond to a length of the work surface, and securing the portable safety device to the work surface. According to one or more aspects or embodiments, the method may further comprise visually indicating securement of the portable safety device to the work surface.

According to one or more aspects, a portable safety device operable to be deployed adjacent to a work surface. The device may include a rail comprising a first rail section telescopically connected to a second rail section and a locking device disposed with the rail. The locking device is operable to secure the rail to the work surface. According to one or more aspects or embodiments, the device may include a signal member. The signal member may be operationally connected to the rail and positioned in a secured signal position in response to the locking device being removably secured to the work surface. The secured signal position provides a visual indicator that the rail is secured to the work surface. According to one or more aspects or embodiments, the device may include a height-adjustment member operatively connected to the rail.

The foregoing has outlined some of the features and technical advantages of one or more embodiments in order that the Detailed Description that follows may be better understood. Additional features and advantages of one or more embodiments will be described hereinafter which form the subject of the claims.

### BRIEF DESCRIPTION OF THE DRAWINGS

The disclosure is best understood from the following Detailed Description when read with the accompanying Figures. It is emphasized that, in accordance with standard practice in the industry, various features are not drawn to scale. In fact, dimensions of various features may be arbitrarily increased or reduced for clarity of discussion.

FIG. 1 is a perspective view of a portable safety device according to an exemplary embodiment;

FIG. 2 is a side view of a first rail section of the portable safety device of FIG. 1 according to an exemplary embodiment;

FIG. 3 is a side view of a second rail section of the portable safety device of FIG. 1 according to an exemplary embodiment;

FIG. 4 is a side view of an additional rail section of the portable safety device of FIG. 1 according to an exemplary embodiment;

FIG. 5A is a side cross-sectional view of the portable safety device of FIG. 1 according to an exemplary embodiment;

FIG. 5B is a perspective view of a section of the portable safety device of FIG. 1 according to an exemplary embodiment;

FIG. 5C is a cross-sectional view taken about section line 5C-5C of the portable safety device of FIG. 5B;

FIG. 5D is a side cross-sectional view of the portable safety device of FIG. 1 according to an exemplary embodiment;

FIG. 6 is a perspective view of a portable safety device secured to a work surface according to an exemplary embodiment;

FIG. 7 is a perspective view of a locking device according to an exemplary embodiment;

FIG. 8 is a perspective view of a signal member according to an exemplary embodiment;

FIG. 9 is an exploded view of the signal member of FIG. 8;

FIG. 10A is a perspective view of the portable safety device secured to a work surface showing the signal member according to an exemplary embodiment;

FIG. 10B is a cross-sectional view of a locking signal member according to an exemplary embodiment;

FIG. 10C is a side view of a portable safety device section according to an exemplary embodiment

FIG. 11 is a side view of a portable safety device section according to an exemplary embodiment;

FIG. 12A is an perspective view of a portable safety device according to an exemplary embodiment;

FIG. 12B is a detail view of a winch of FIG. 12A;

FIG. 12C is a detail view of an intermediate support of FIG. 12A; and

FIG. 12D is a detail view of a termination bracket of FIG. 12A.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

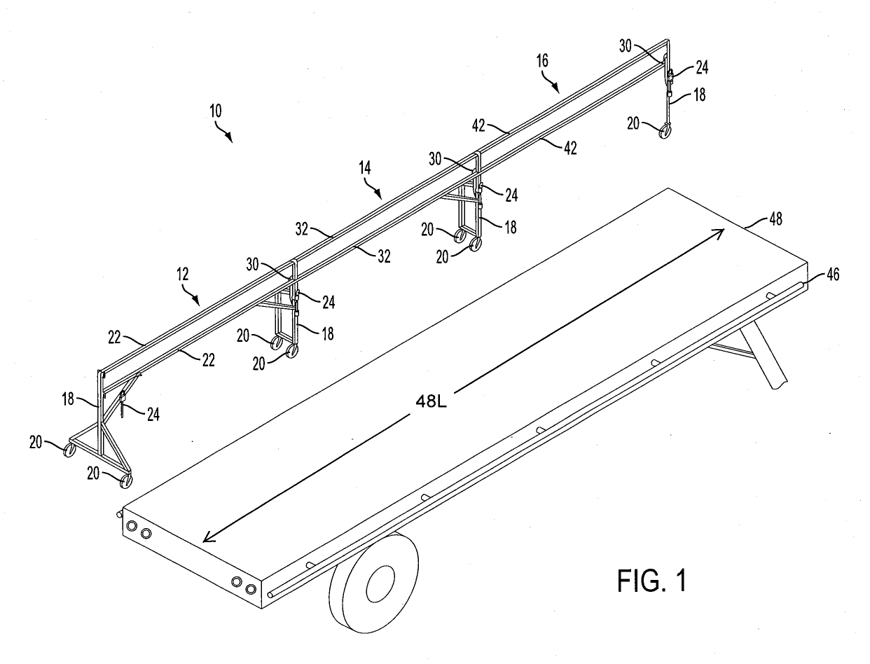

FIG. 1 is a perspective view of a portable safety device, generally denoted by the numeral 10, according to one or more embodiments of the invention. The portable safety device 10 is also referred to herein as a rail 10, or a rail system 10. The portable safety device 10 comprises a first rail section 12 and a second rail section 14. FIG. 1 depicts an embodiment of the portable safety device 10 comprising the first rail section 12, the second rail section 14, and an additional rail section 16. Each of the first rail section 12, the second rail section 14, and the additional rail section 16 include at least one vertical leg 18 having at least one wheel 20 attached thereto. In a typical embodiment, the at least one vertical leg 18 is at least partially filled with a heavy material such as, for example, steel particles (commonly referred to as “millscale”). Use of the heavy material imparts additional stability to the portable safety device 10. At least one horizontal beam 22, 32, 42 is disposed generally orthogonal to the at least one vertical leg 18. As will be discussed in more detail hereinbelow, each of the first rail section 12, the second rail section 14, and the additional rail section 16 slide in a linear fashion with respect to each other. In this manner a total length of the portable safety device 10 may be adjusted to accommodate work areas 48 of differing lengths 48L such as, for example, a flatbed trailer 48. Each of the first rail section 12, the second rail section 14, and the additional rail section 16 may be constructed of any appropriate material such as, for example, steel or aluminum square tubing. The portable safety device 10 is shown by way of example in FIG. 1 as having three sections; however, one skilled in the art will recognize that any number of second rail sections 14 or additional rail sections 16 could be incorporated into the portable safety device 10.

For the purpose of brevity and clarity in describing use of the portable safety device 10, the work surface/area 48 is depicted in various FIGURES with respect to a flatbed trailer. However, it will be recognized by those skilled in the art and with benefit of this disclosure that the portable safety device may be utilized with other work surfaces.

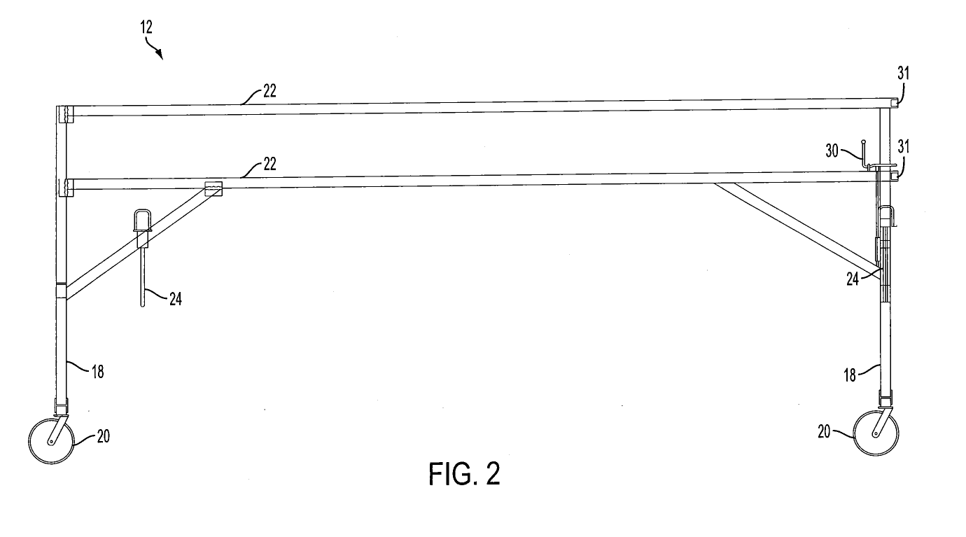

FIG. 2 is a side view of a first rail section of the portable safety device of FIG. 1 according to an exemplary embodiment. The first rail section 12 includes the at least one vertical leg 18 having the at least one wheel 20 connected thereto. The at least one wheel 20 may be, for example, a swivel-type wheel to allow easy movement and positioning of the portable safety device 10. Moreover, in various embodiments, the at least one wheel 20 may take the form of, for example, a skid or other device to facilitate movement of the portable safety device 10. The at least one horizontal beam 22 is positioned adjacent to the at least one vertical leg 18. In an exemplary embodiment, the at least one horizontal beam 22 includes at least one slot 31 disposed at a first end. While FIG. 2 illustrates, by way of example, two horizontal beams 22, one skilled in the art will recognize that any number of horizontal beams 22 may be included. At least one locking device 24 is connected to the first rail section 12. A signal member 30 may be connected to the at least one vertical leg 18.

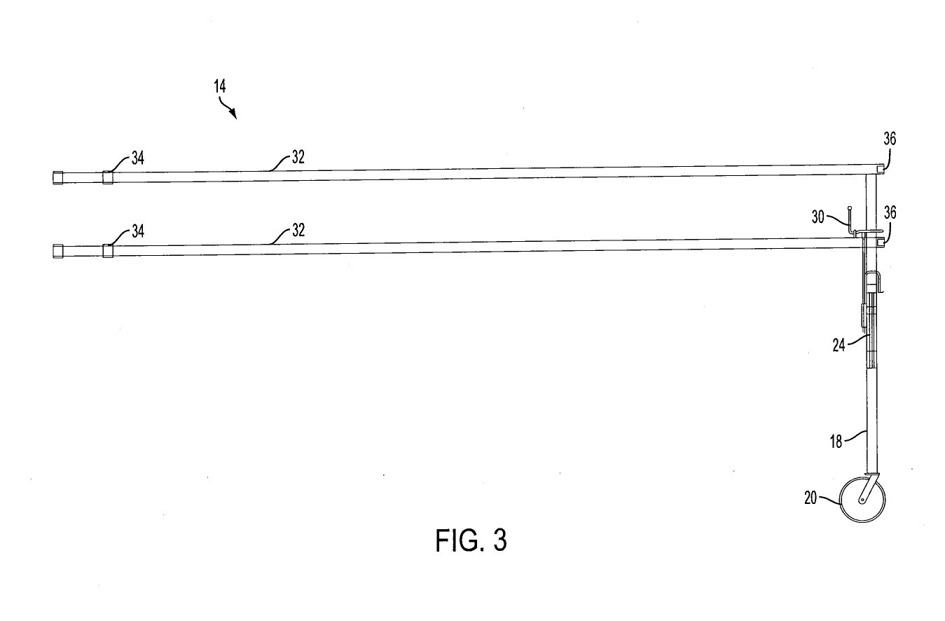

FIG. 3 is a side view of a second rail section of the portable safety device of FIG. 1 according to an exemplary embodiment. The second rail section 14 includes at least one vertical leg 18 having at least one wheel 20 attached thereto. The at least one horizontal beam 32 is connected to the at least one vertical leg 18. In an exemplary embodiment, the at least one horizontal beam 32 has a slightly smaller diameter than that of the at least one horizontal beam 22 (shown in FIG. 2). At least one stop 34 is located at a first end of the at least one horizontal beam 32. At least one slot 36 is disposed at an opposite end of the at least one horizontal beam 32 from the at least one stop 34. In addition, the at least one locking device 24 is connected to the at least one vertical leg 18. The signal member 30 is connected to the at least one vertical leg 18.

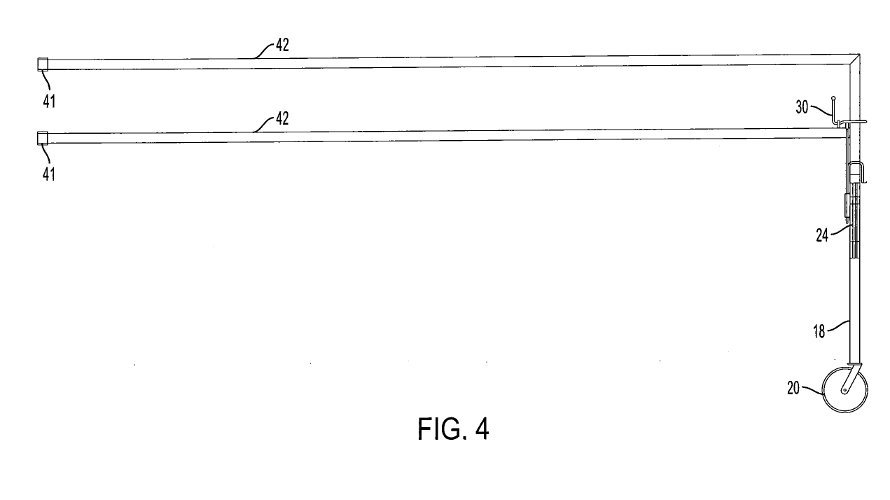

FIG. 4 is a side view of an additional rail section of the portable safety device of FIG. 1 according to an exemplary embodiment. The additional rail section 16 includes at least one vertical leg 18 having at least one wheel 20 attached thereto. At least one horizontal beam 42 is connected to the at least one vertical leg 18. In an exemplary embodiment, the at least one horizontal beam 42 has a slightly smaller diameter than that of the at least one horizontal beam 32 (shown in FIG. 3). A stop 41 is located at a first end of the at least one horizontal beam 42. In addition, the at least one locking device 24 is connected to the at least one vertical leg 18. The signal member 30 is connected to the at least one vertical leg 18.

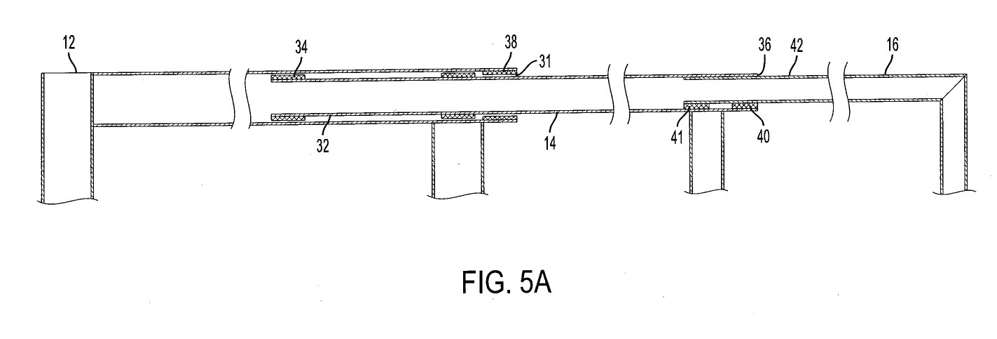

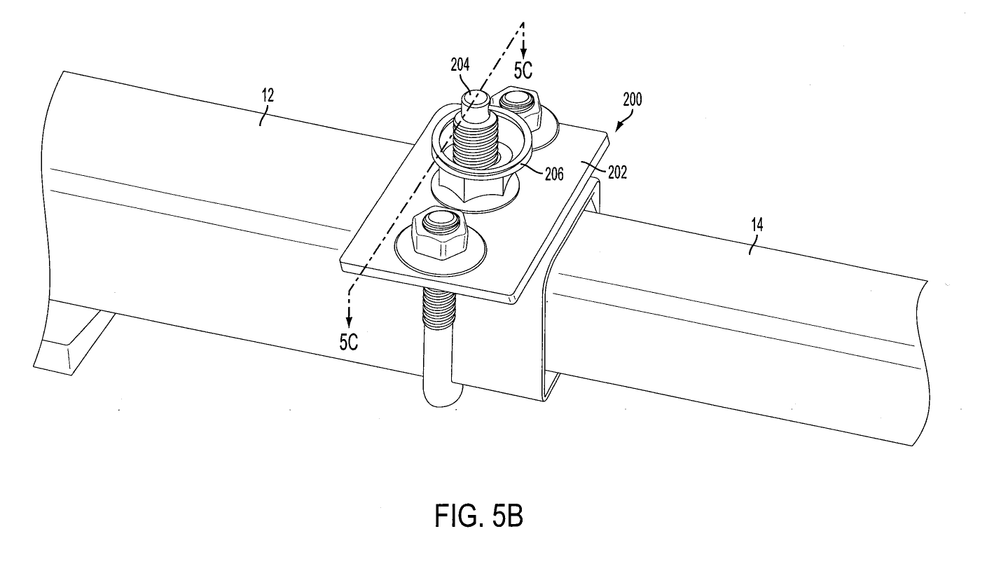

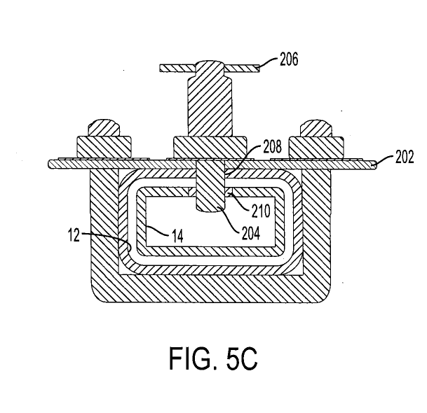

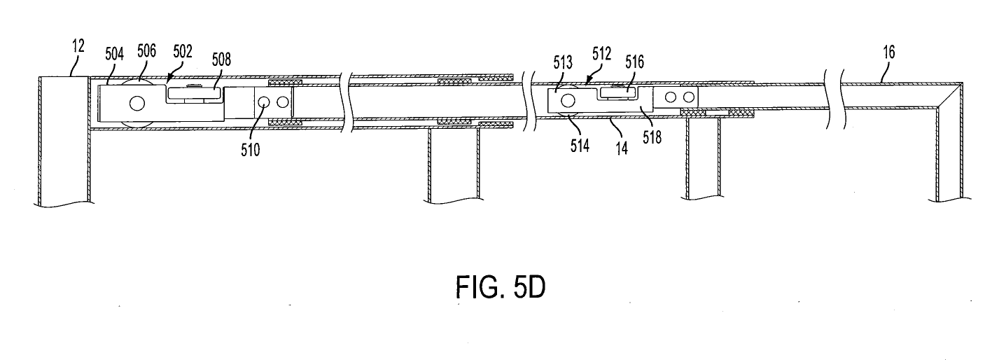

FIG. 5A is a side cross-sectional view of the portable safety device of FIG. 1 according to an exemplary embodiment. During operation, the at least one horizontal beam 32 of the second rail section 14 is inserted into the at least one slot 31 of the first rail section 12. In this manner, the second rail section 14 is permitted to slide in a telescoping fashion relative to the first rail section 12. In an exemplary embodiment, at least one stop 38 is disposed inside the at least one horizontal beam 22. During operation, the interaction of the at least one stop 38 with the at least one stop 34 prevents accidental disengagement of the second rail section 14 from the first rail section 12.

Still referring to FIG. 5A, at least one stop 40 is disposed inside the at least one horizontal beam 32. During operation, the at least one horizontal beam 42 is inserted into the at least one slot 36 of the second rail section 14. In this manner, the additional rail section 16 is permitted to slide in a telescoping fashion relative to the second rail section 14. Interaction of the at least one stop 41 with the at least one stop 40 prevents accidental disengagement of the additional rail section 16 from the second rail section 14. In this matter, the portable safety device 10 is capable of being extended in a telescoping fashion so as to accommodate work surfaces of differing lengths such as, for example, the flatbed trailer 48.

FIG. 5B is a perspective view of a section of the portable safety device of FIG. 1 according to an exemplary embodiment. In various embodiments, the first rail section 12, the second rail section 14, and the additional rail section 16 may include a connector 200. In various embodiments, the connector 200 is disposed proximate to a junction between, for example, the first rail section 12 and the second rail section 14. The connector 200 includes a receiver 202, a bolt 204, and a pull ring 206. The receiver 202 is positioned on an exterior surface of the first rail section 12 proximate to a junction between, for example, the first rail section 12 and the second rail section 14. The bolt 204 is slidably disposed within the receiver 202. A first aperture 208 (shown in FIG. 5C) is formed in the first rail section 12 proximate the receiver 202 and a second aperture 210 (shown in FIG. 5C) is formed in the second rail section 14 below the first aperture 208.

FIG. 5C is a cross-sectional view taken about section line 5C-5C of the portable safety device of FIG. 5B according to an exemplary embodiment. During operation, the second rail section 14 is extended from the first rail section 12 to a point where the first aperture 208 aligns with the second aperture 210. When the first aperture 208 and the second aperture 210 align, the bolt 204 engages the first aperture 208 and the second aperture 210 preventing further extension of the second rail section 14 and, thus, preventing accidental disengagement of the second rail section 14 from the first rail section 12. The pull ring 206 is utilized to disengage the bolt 204 from the first aperture 208 and the second aperture 210. In a typical embodiment, the bolt 204 is biased by operation of gravity; however, in various alternative embodiments, a spring (not explicitly shown) is utilized to bias the bolt 204 to engage the first aperture 208 and the second aperture 210. In various embodiments, the connector 200 may be disposed proximate to a junction between, for example, the second rail section 14 and the additional rail section 16. In still other embodiments, the connector 200 may be disposed proximate to a junction between, for example, two second rail sections 14.

FIG. 5D is a side cross-sectional view of the portable safety device of FIG. 1 according to an exemplary embodiment. A first bearing assembly 502 includes a truck 504, a first vertical wheel 506, a first horizontal wheel 508, and a connector 510. The truck 504 is disposed within the first rail section 12 and connected to an end of the second rail section 14 via the connector 510. In one or more embodiments, the connector 510 may be, for example, screws, pins, or any appropriate connector. In various other embodiments, the truck 504 may be connected to the second rail section 14 through a process such as welding. The first vertical wheel 506 is disposed in the truck 504 and is free to rotate about an axis. In similar fashion, the first horizontal wheel 508 is disposed in the truck 504 and free to rotate about an axis. The first vertical wheel 506 and the first horizontal wheel 508 engage an interior surface of the first rail section 12. The first bearing assembly 502 reduces friction associated with movement of the second rail section 14 relative to the first rail section 12.

Still referring to FIG. 5D, a second bearing assembly 512 includes a truck 513, a second vertical wheel 514, a second horizontal wheel 516, and a connector 518. The truck 513 is disposed within the second rail section 14 and connected to an end of the additional rail section 16 via the connector 518. In one or more embodiments, the connector 518 may be, for example, screws pins, or any appropriate connector. In various other embodiments, the truck 513 may be connected to the additional rail section 16 through a process such as welding. The second vertical wheel 514 is disposed in the truck 513 and free to rotate about an axis. In similar fashion, the second horizontal wheel 516 is disposed in the truck 513 and free to rotate about an axis. The second vertical wheel 514 and the second horizontal wheel 516 engage an interior surface of the second rail section 14. The second bearing assembly 512 reduces friction associated with movement of the additional rail section 16 relative to the second rail section 14.

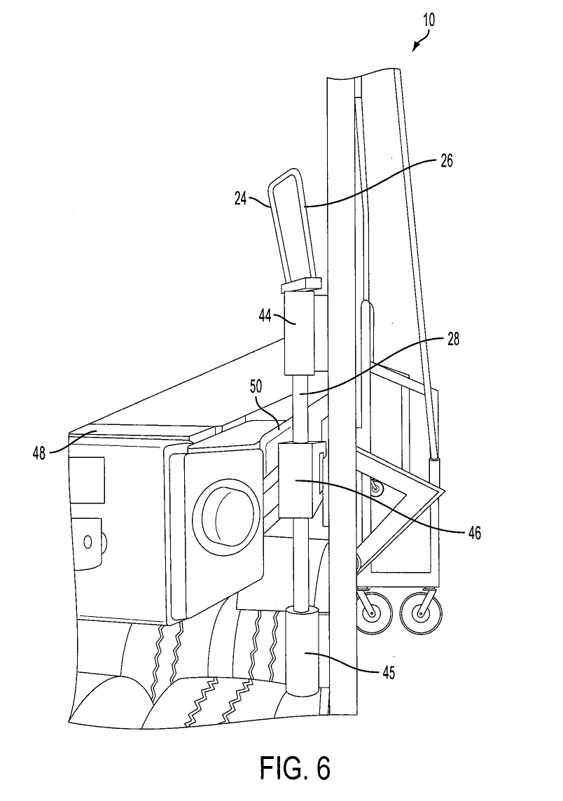

FIG. 6 is a perspective view of a portable safety device secured to a work surface according to an exemplary embodiment. The at least one locking device 24 includes a handle 26 and a pin 28. A first guide cylinder 44 and a second guide cylinder 45 are secured to a portion of the portable safety device 10. In various embodiments the first guide cylinder 44 and the second guide cylinder 45 are arranged such that the first guide cylinder 44 is positioned, for example, above a tie-down rail 46 of the flatbed trailer 48 and the second guide cylinder 45 is positioned below the tie-down rail 46.

Still referring to FIG. 6, during operation, the portable safety device 10 is moved into position adjacent to a work surface such as, for example, the flatbed trailer 48. The first guide cylinder 44 is positioned above the tie-down rail 46 and the second guide cylinder 45 is positioned below the tie-down rail 46 as discussed above. The pin 28 is inserted through the first guide cylinder 44, passed between the tie-down rail 46 and an edge 50 of the flatbed trailer 48, and inserted through the second guide cylinder 45 thereby securing the portable safety device 10 to the flatbed trailer 48. Such an arrangement prevents movement of the portable safety device 10 away from the flatbed trailer 48 during use. In a typical embodiment, the first guide cylinder 44 and the second guide cylinder 45 are separated by sufficient vertical distance to accommodate variations in height of the work surface such as, for example, the flatbed trailer 48. In particular, spacing between the first guide cylinder 44 and the second guide cylinder 45 accommodates height variations associated with, for example, air-ride suspensions commonly utilized with flatbed trailers.

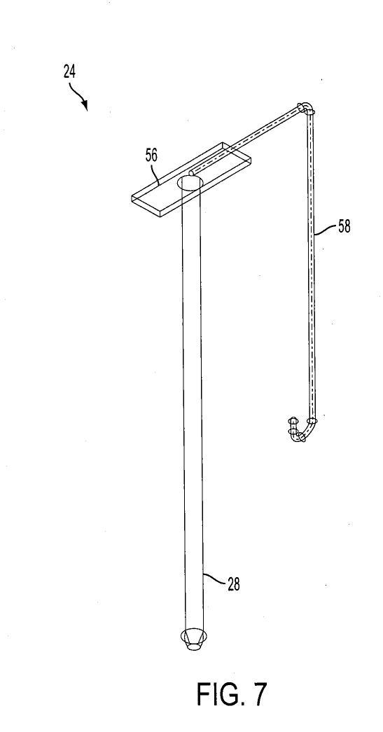

FIG. 7 is a perspective view of a locking device according to an embodiment. A locking device 24 includes the pin 28. A plate 56 is secured to a top portion of the pin 28 with a hook 58 connected thereto. Referring to FIGS. 6 and 7, during operation, the pin 28 is inserted through the first guide cylinder 44, passed between the tie-down rail 46 and the edge 50 of the flatbed trailer 48, and inserted through the second guide cylinder 45 as described above. The hook 58 engages either a lower aspect of the tie-down rail 46 or a lower aspect of the second guide cylinder 45 thereby securing the locking device 24 in place. Engagement of the hook 58 prevents removal of the locking device 24 by a worker standing on a deck of the flatbed trailer 48. That is, the locking device 24 may be removed only by a worker at ground level.

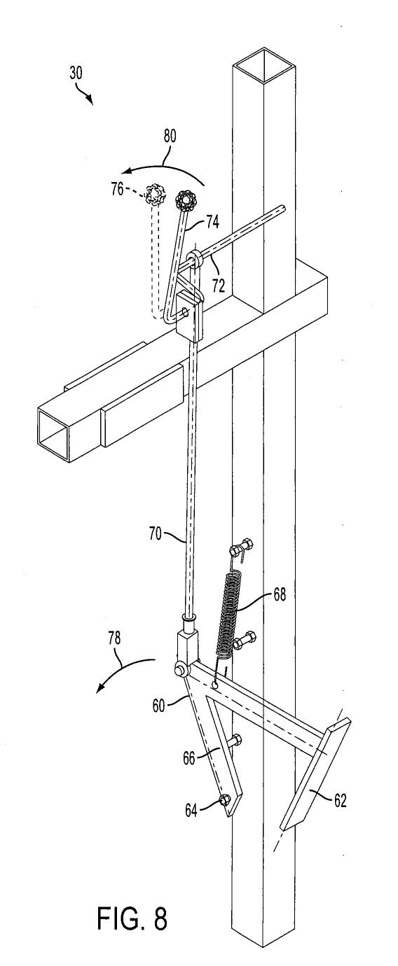

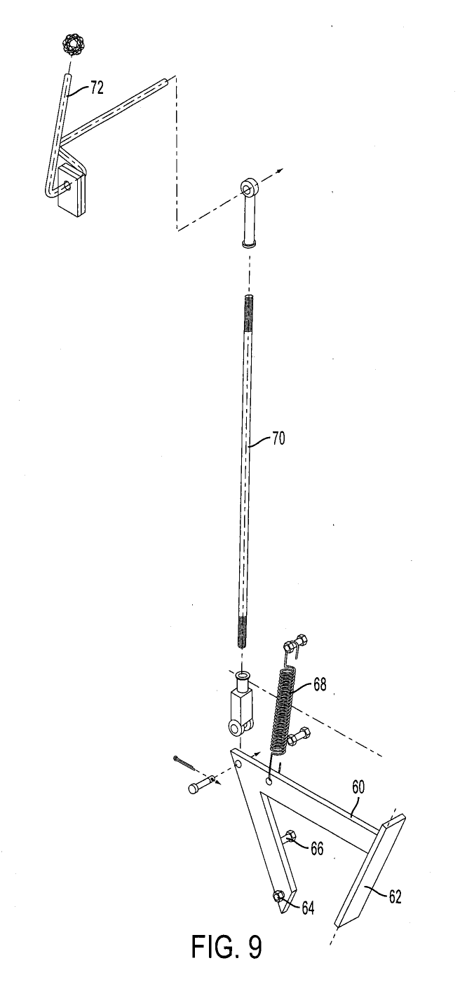

FIG. 8 is a perspective view of a signal member according to an exemplary embodiment. FIG. 9 is an exploded view of the signal member of FIG. 8. The signal member 30 includes a lever 60 having a contacting plate 62 secured thereto. The lever 60 is secured to a portion of the portable safety device 10 by a pin 64 in such a manner that the lever 60 is free to rotate about the pin 64. A stop 66 is disposed above the pin 64 and prevents full rotation of the lever 60. A spring 68 biases the lever 60 against the stop 66. A connector rod 70 is connected to the lever 60 and extends upwardly therefrom. The connector rod 70 is connected to an indicator flag 72. The indicator flag 72 is disposed, for example, on the at least one horizontal beam 22, 32, 42. In an exemplary embodiment, the indicator flag 72 is capable of rotating between an unsecured signal position 74 and a secured signal position 76.

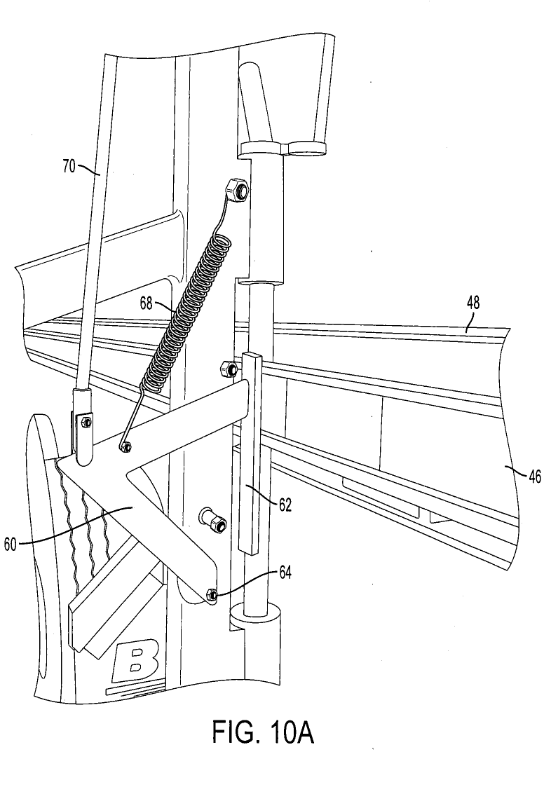

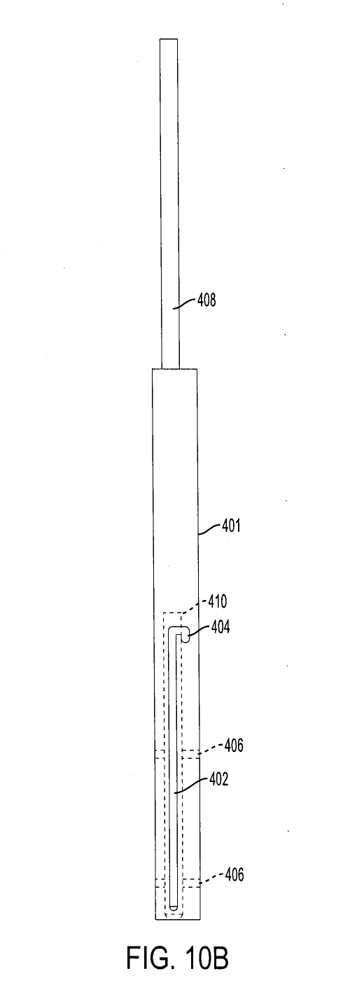

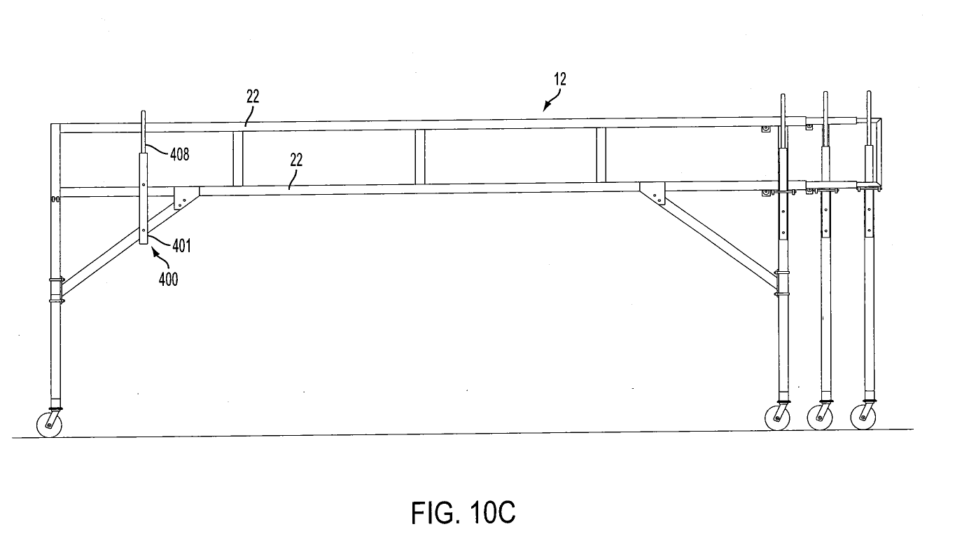

FIG. 10A is a perspective view of the portable safety device secured to a work surface according to an exemplary embodiment. Referring now to FIGS. 8, 9, and 10 collectively, during operation, when the portable safety device 10 is placed adjacent to a work surface such as, for example, the flatbed trailer 48, the tie-down rail 46 comes into contact with the contacting plate 62. Contact pressure between the contacting plate 62 and the tie-down rail 46 causes the lever 60 to rotate in a direction shown by arrow 78 against the bias exerted by the spring 68. Movement of the lever 60 causes the connector rod 70 to move in a downward fashion with respect to the portable safety device 10 thereby causing the indicator flag 72 to move in a direction shown by arrow 80. In this manner, a visual indication is provided so that individuals working on the work surface such as, for example, the flatbed trailer 48 can easily determine if the portable safety device 10 is safely secured to the work surface.

FIG. 10B is a cross-sectional view of a locking signal member according to an exemplary embodiment. A locking signal member 400 includes a sleeve 401 having a groove 410 and slots 406 formed therein, a locking rod 402, and an indicator 408. In a typical embodiment, the sleeve 401 is connected to at least one of the first rail section 12, the second rail section 14, and the additional rail section 16. By way of example, in various embodiments, the sleeve 401 may be connected to the at least one horizontal beam 22, 32, 42. The locking rod 402 is slidably disposed within the sleeve 401. A handle 404 is formed on an upper aspect of the locking rod 402. The handle 404 protrudes from the sleeve 401 through the groove 410 and is accessible by a worker. During operation, the worker may slide the handle 404 upwardly or downwardly in the groove 410 to move the locking rod 402 between a secured position and an unsecured position. When in the secured position, the locking rod 402 engages the tie-down rail 46 (shown in FIG. 10A) thereby securing the portable safety device 10 to the work surface such as, for example, the flatbed trailer 48 When the handle 404 is placed in a desired location, the handle 404 may be turned to engage the slots 406. The slots 406 secure the handle 404 and the locking rod 402 in place.

FIG. 10C is a side view of a portable safety device section according to an exemplary embodiment. Referring to FIGS. 10B and 10C, the indicator 408 is connected to the upper aspect of the locking rod 402. The indicator protrudes from a top of the sleeve 401. As the handle 404 is moved between an unsecured position and a secured position, the indicator 408 moves between an unsecured signal position and a secured signal position. In a typical embodiment, the indicator 408, when in the unsecured signal position, extends above the at least one horizontal rail 22, 32, 42 thereby providing visual indication of whether the portable safety device 10 is secured to the flatbed trailer 48.

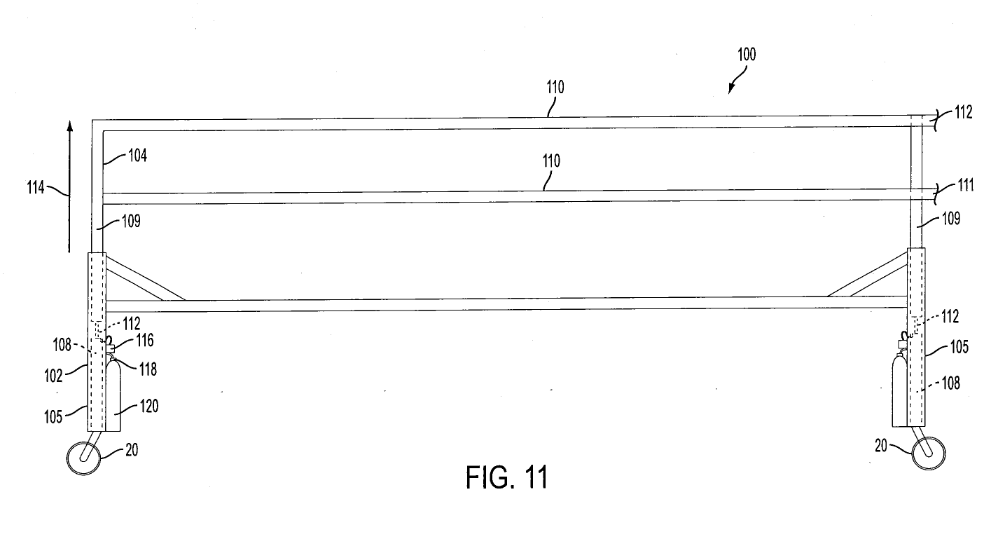

FIG. 11 is a side view of a portable safety device section according to an exemplary embodiment. The rail-system section 100 includes a lower section 102 and an upper section 104. The lower section 102 includes at least one vertical leg 105 having at least one wheel 20 connected thereto. The at least one wheel 20 may be, for example, swivel-type wheels to allow easy movement and positioning of the portable safety device 10. At least one pneumatic cylinder 108 is disposed inside of the at least one vertical leg 105.

Still referring to FIG. 11, the upper section 104 includes at least one vertical leg 109. At least one horizontal beam 110 is positioned between the at least one vertical leg 109. In an exemplary embodiment, the at least one horizontal beam 110 includes at least one slot 111 disposed at a first end. While FIG. 11 illustrates, by way of example, two horizontal beams 110, one skilled in the art will recognize that any number of horizontal beams 110 may be included. In a typical embodiment, the at least one vertical leg 109 is of slightly smaller diameter than the at least one vertical leg 105 thus allowing the at least one vertical leg 109 to be disposed inside the at least one vertical leg 105 in a telescoping manner.

Still referring to FIG. 11, during operation, a user actuates a control unit (not shown). The control unit actuates a pump 116 and a valve 118. The pump 116 and the valve 118 allow a fluid to flow from a cylinder 120 to the at least one pneumatic cylinder 108. Flow of air into the at least one pneumatic cylinder 108 causes a piston 112 to extend from the at least one pneumatic cylinder 108. The piston 112 engages the at least one vertical leg 109 thereby causing the upper section 104 to move in a direction of the arrow 114. In this manner, the rail-system section 100 can be adjusted to accommodate various fall heights. Though not specifically shown in FIG. 11, rail-system section 100 may be used in conjunction with the second rail section 14 and the additional rail section 16 in the manner described above to allow the portable safety device 10 to be length adjustable to accommodate work areas of differing lengths.

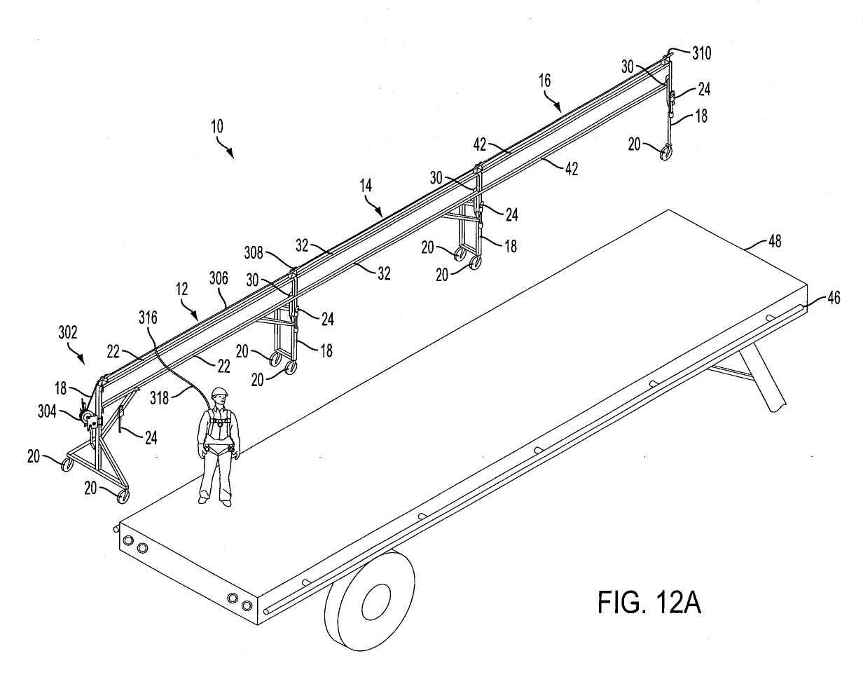

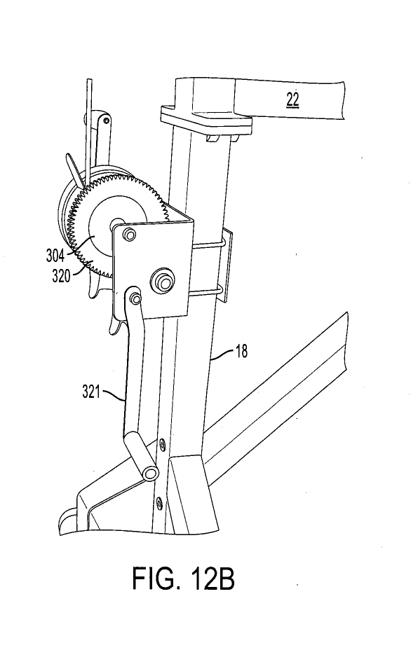

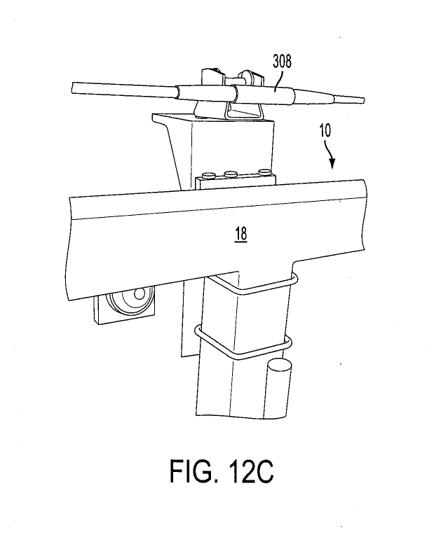

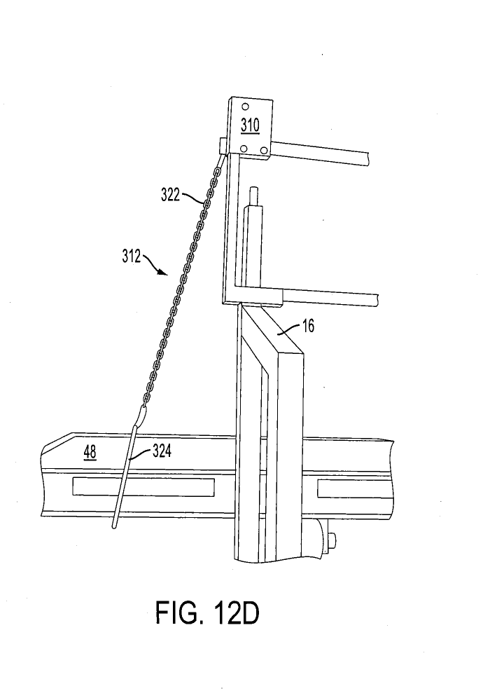

FIG. 12A is a perspective view of a portable safety according to an exemplary embodiment. In one or more embodiments, the portable safety device 10 includes a cable-support system 302. The cable-support system 302 includes a winch 304, a cable 306, a plurality of intermediate supports 308, a termination bracket 310, and a binder 312 (shown in FIG. 12D). The winch 304 is secured to the at least one vertical leg 18 of the first rail section 12. The cable 306 is secured around the winch 304. The cable 306 is extended up the at least one vertical leg 18, over a pulley 314, and generally parallel to a length of the first rail section 12, the second rail section 14, and the additional rail section 16. The plurality of intermediate supports 308 are positioned along the length of the first rail section 12, the second rail section 14, and the additional rail section 16. The plurality of intermediate supports 308 maintain proper positioning of the cable 306 relative to the first rail section 12, the second rail section 14, and the additional rail section 16. The termination bracket 310 is secured to the additional rail section 16. The cable 306 is secured to the termination bracket 310. The binder 312 is also secured to the additional rail section 16.

FIG. 12B is a detail view of a winch of FIG. 12A. In a typical embodiment, the winch 304 is secured to the at least one vertical leg 18; however, in various alternative embodiments, the winch 304 could be secured to any other aspect of the portable safety device 10 such as, for example, the at least one horizontal beam 22. The winch 304 includes a ratcheting member 320. In a typical embodiment, the ratcheting member 320 prevents the winch 304 from unwinding when tension is applied to the cable 306. In the embodiment shown in FIG. 12B, the winch 304 includes a hand crank 321; however, in various alternative embodiments, the winch 304 may be powered by, for example, an electric motor.

FIG. 12C is a detail view of an intermediate support of FIG. 12A. The plurality of intermediate supports 308 are positioned proximate to the at least one vertical leg 18; however, in various alternative embodiments, the plurality of intermediate supports may be positioned elsewhere along the length of the portable safety device 10. The plurality of intermediate supports 308 comprise a tapered shape. The tapered shape allows a shuttle 316 disposed about the cable 306 to pass over the plurality of intermediate supports 308 without impediment.

FIG. 12D is a detail view of a termination bracket of FIG. 12A. The termination bracket 310 is mounted to the additional rail section 16. In a typical embodiment, the termination bracket 310 provides a fixed anchor point for the cable 306. The binder 312 is also coupled to the additional rail section 16. In a typical embodiment, the binder 312 comprises a chain 322 and a tensioner 324. During operation, the chain 322 is secured to the flatbed trailer 48. The tensioner 324 is utilized to remove slack from the chain 322. In a typical embodiment, the binder 312 prevents the portable safety device 10 from retracting when tension is applied to the cable 306.

Referring now to FIGS. 12A-12D, during operation, the additional rail section 16 and the second rail section 14 are each extended relative to the first rail section 12 as described above. During extension, the cable 306 pays out from the winch 304 and extends along a length of the first rail section 12, the second rail section 14, and the additional rail section 16. When the portable safety device 10 is adjusted to a desired length, the winch 304 is actuated to remove any slack from the cable 306. The shuttle 316 is slidably disposed about the cable 306. In a typical embodiment, the shuttle 316 smoothly passes over the plurality of intermediate supports 308 thereby allowing the shuttle 316 to traverse a length of the cable 306. In a typical embodiment, a harness 318 is attached to the shuttle. The harness 318 may be worn by a user as an additional fall-prevention measure. Use of the harness 318 is particularly advantageous in applications where it is desirable for one side of the flatbed trailer 48 to remain open such as, for example, applications involving low ceiling clearance heights. In an exemplary embodiment, the shuttle 316 and the plurality of intermediate supports 308 are available from Miller Fall Protection.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an,” and other singular terms are intended to include the plural forms thereof unless specifically excluded.

What is claimed is:

1. A portable safety device operable to be deployed adjacent to a work surface, the device comprising:
a rail comprising a first rail section telescopically connected to a second rail section;
a locking device disposed with the rail; and
a signal member operationally connected to the rail and positioned in a secured signal position in response to the locking device being secured to the work surface, wherein the secured signal position provides a visual indicator that the rail is secured to the work surface.

2. The portable safety device of claim 1, wherein the work surface is a flatbed trailer.

3. The portable safety device of claim 1, wherein the locking device comprises a pin operable to engage the work surface and secure the rail thereto.

4. The portable safety device of claim 3, wherein the locking device comprises a hook for locking the locking device in a position securing the rail to the work surface.

5. The portable safety device of claim 1, wherein the signal member comprises:
a lever;
a rod operatively coupled to the lever;
a flag operatively coupled to the rod wherein, upon securement of the rail to the work surface, the temporary work surface engages the lever thereby inducing the flag to move from an unsecured signal position to the secured signal position.

6. The portable safety device of claim 1, further comprising:
a first plurality of stops disposed with the first rail section; and
a second plurality of stops disposed with the second rail section wherein the first plurality of stops and the second plurality of stops secure the first rail section to the second rail section.

7. The portable safety device of claim 1, further comprising a pneumatic cylinder disposed with the rail wherein the pneumatic cylinder allows height adjustment of the rail.

8. The portable safety device of claim 1, further comprising a connector disposed proximate to a junction between the first rail section and the second rail section wherein the connector secures the first rail section to the second rail section.

9. The portable safety device of claim 1, further comprising:
a winch coupled to the rail;
a cable secured about the winch, the cable extending in a direction generally parallel to a length of the rail;
a shuttle disposed on the cable, the shuttle operable to traverse a length of the cable; and
a harness operatively coupled to the shuttle.

10. A method comprising:
positioning a portable safety device adjacent a work surface, the portable safety device comprising a rail, a locking device, and a signal member;
adjusting a length of the rail to correspond to a length of the work surface;
securing the rail to the work surface via the locking device; and
moving the signal member from an unsecured signal position to a secured signal position responsive to contacting pressure between the signal member and the work surface.

11. The method of claim 10, further comprising adjusting a height of the portable safety device.

12. The method of claim 10, wherein said securing comprises operatively engaging a pin to the work surface.

13. The method of claim 10, wherein the locking device comprises a hook for locking the locking device in a position securing the rail to the work surface.

14. The method of claim 10, wherein said moving comprises:
responsive to contacting pressure between the work surface and a lever, actuating a rod operatively coupled to the lever; and
moving a flag operatively coupled to the rod from the unsecured signal position to the secured signal position.

15. The method of claim 10, further comprising:
positioning a cable generally parallel to a length of the rail;
adjusting a length of the cable to correspond to the length of the rail;
tensioning the cable; and
securing a person positioned on the work surface to the cable.

16. A portable safety device operable to be deployed adjacent to a work surface, the device comprising:
a rail comprising a first rail section telescopically connected to a second rail section;
a locking device disposed with the rail;
a signal member operationally connected to the rail and positioned in a secured signal position in response to the locking device being removably secured to the work surface, wherein the secured signal position provides a visual indicator that the rail is secured to the work surface; and
a height-adjustment member operatively connected to the rail.

17. The portable safety device of claim 16, wherein the height-adjustment member comprises a pneumatic cylinder.

18. The portable safety device of claim 16, further comprising:
a connector disposed proximate to a junction between the first rail section and the second rail section to secure the first rail section to the second rail section.

19. The portable safety device of claim 16, further comprising:
a winch coupled to the rail;
a cable secured about the winch, the cable extending in a direction generally parallel to the rail;
a shuttle disposed on the cable, the shuttle operable to traverse a length of the cable; and
a harness operatively coupled to the shuttle.

20. The portable safety device of claim 16, wherein the signal member comprises:
a lever;
a rod operatively coupled to the lever;
a flag operatively coupled to the rod; and
wherein, upon securement of the rail to the work surface, the work surface engages the lever thereby inducing the flag to move from an unsecured signal position to the secured signal position.
